(19) United States
(12) Patent Application Publication
(10) Pub. No.: US 2014/0035724 A1
(43) Pub. Date: Feb. 6, 2014

(54) SYSTEMS AND METHODS FOR LOCATING INVENTORY ITEMS

(71) Applicant: Leigh M. Rothschild, Sunny Isles Beach, FL (US)

(72) Inventor: Leigh M. Rothschild, Sunny Isles Beach, FL (US)

(73) Assignee: REAGAN INVENTIONS, LLC, Sunny Isles Beach, FL (US)

(21) Appl. No.: 13/566,020

(22) Filed: Aug. 3, 2012

(51) Int. Cl. G08C 17/02; G08B 1/08

(52) U.S. Cl. 340/8.1; 340/10.1

(57) ABSTRACT

Systems and methods for locating inventory items are provided. A system according to one implementation comprises a plurality of inventory items and a radio frequency identification (RFID) tag attached to each of the plurality of inventory items. The system also includes a plurality of RFID readers positioned at predetermined, stationary locations throughout a search area. Also, the system includes a computer configured to determine a location of a selected inventory item based at least on search results of the RFID readers.

### TECHNICAL FIELD

The present disclosure generally relates to radio frequency identification (RFID), and more particularly relates to locating inventory items using RFID.

### BACKGROUND

Retail stores may have thousands of different items in stock. These items are typically displayed in some manner, such as on shelves or on other display structures, so that customers can easily see and handle the items. Sometimes, however, a customer might pick up an item with an intention of possibly purchasing the item, but then later decide not to buy it. In these situations, customers occasionally do not put the items back where they were originally picked up. There may be other reasons that items may be placed in the wrong location, such as if an employee responsible for restocking items makes a mistake. When these items are misplaced, it will typically be more difficult for later customers to find the items when desired.

Also, various stores electronically track items and the purchase activity of these items. An example of such an electronic tracking system employs radio frequency identification (RFID) tags. An RFID tag is applied to each item to be tracked. Information relating to the item is stored in the RFID tag and may be retrieved by an appropriate reading device. RFID tags are conventionally employed for inventory control where items are taken out of inventory or stock as each RFID tag is read at the time of purchase. If the items are determined to be in stock, the stores may assume that they are either readily available to the customers. However, if the items are in stock but someone checks in the place where the items should be and discovers that the items are missing, they might assume that the items have been stolen.

Some stores, such as Blockbuster, may provide a service that allows customers to rent items, such as DVDs. The items in this type of environment may also be picked up and moved around the store and then later placed back in a location that does not match its proper category. Again, this may cause a problem for later customers who may wish to rent a particular item, but the item is not where it should be.

In addition to retail stores, rental stores, and other variety stores that sell or rent merchandise, there are other facilities, such as libraries, which may also wish to track items (e.g., books) to properly manage their inventory. Therefore, various businesses, other stores including clothing stores, libraries, hospitals, schools, or other entities may utilize inventory systems for keeping track of various types of items. However, when these items are placed in a location where they are not intended to be stored, finding those items can be very difficult and time-consuming.

### SUMMARY

The present disclosure describes systems and methods for locating inventory items in a search area. An exemplary item locating system, according to one implementation of the present disclosure, comprises a plurality of inventory items and a radio frequency identification (RFID) tag attached to each of the plurality of inventory items. The system also includes a plurality of RFID readers positioned at predetermined, stationary locations throughout a search area. Also, the system includes a computer configured to determine a location of a selected inventory item based at least on search results of the RFID readers.

An exemplary method, according to one implementation of the present disclosure, includes the steps of enabling a user to select an inventory item using a user interface device and retrieving radio frequency identification (RFID) information associated with the selected inventory item from a database. Another step includes sequentially communicating the RFID information to a plurality of RFID readers placed in predetermined, stationary locations throughout a search area. Also, the method includes receiving search results from the plurality of RFID readers and determining a location of the inventory item within the search area based at least on the search results.

According to a further implementation, a method is provided including, inter alia, enabling a user to select an inventory item using a user interface device; retrieving radio frequency identification (RFID) information associated with the selected inventory item from a database; sequentially communicating the RFID information to a plurality of RFID readers placed in predetermined, stationary locations throughout a search area, each of the RFID readers having a predetermined search range, wherein the plurality of RFID readers are arranged so that the search ranges of adjacent RFID readers overlap; receiving search results from the plurality of RFID readers; and determining a location of the inventory item within the search area based the search results from at least two RFID readers.

### BRIEF DESCRIPTION OF THE DRAWINGS

The features illustrated in the following figures are intended to emphasize the general principles of the present disclosure and are not necessarily drawn to scale. Consistent reference characters are used throughout the figures to designate corresponding features.

FIG. 1 is a diagram illustrating an inventory item with an attached RFID tag, according to one embodiment.

FIG. 2 is a diagram illustrating an underside of the RFID tag shown in FIG. 1, according to one embodiment.

FIG. 3 is a diagram illustrating a floor plan of an exemplary store, according to one embodiment.

FIG. 4 is a diagram illustrating an exemplary positioning of RFID readers throughout the store shown in FIG. 3 and the corresponding electromagnetic field range of the RFID readers, according to various implementations of the present disclosure.

FIG. 5 is a block diagram illustrating an inventory system according to various implementations of the present disclosure.

FIG. 6 is a block diagram illustrating the computer shown in FIG. 5, according to various implementations of the present disclosure.

FIG. 7 is a flow diagram illustrating a method for determining the location of inventory items, according to various implementations of the present disclosure.

### DETAILED DESCRIPTION

The present disclosure describes systems and methods for locating inventory items located within a predefined area, such as within the confines of a store, retail establishment, library, school, hospital, office building, or other entity that may benefit from an inventory system for tracking a number of items. To locate items according to the embodiments of the present disclosure, radio frequency identification (RFID) tags are placed on each item. The RFID tags are configured to store information (e.g., serial numbers, product-related information, stock numbers, etc.) that may be used to identify the items. According to the present disclosure, the item locating systems include a plurality of RFID readers positioned in predefined, stationary locations throughout the area. Each of the RFID readers has a limited range with respect to being able to receive signals back from an RFID tag. In operation, a customer or an employee of a store may wish to locate a certain item, such as an item that is not located where it is supposed to be. Using an identification associated with the item, the RFID readers attempt to communicate with the RFID tag attached to the desired inventory item. When one, or perhaps more, RFID readers pick up signals from the RFID tag, an indication can be provided to point the customer or employee to the general location of the item.

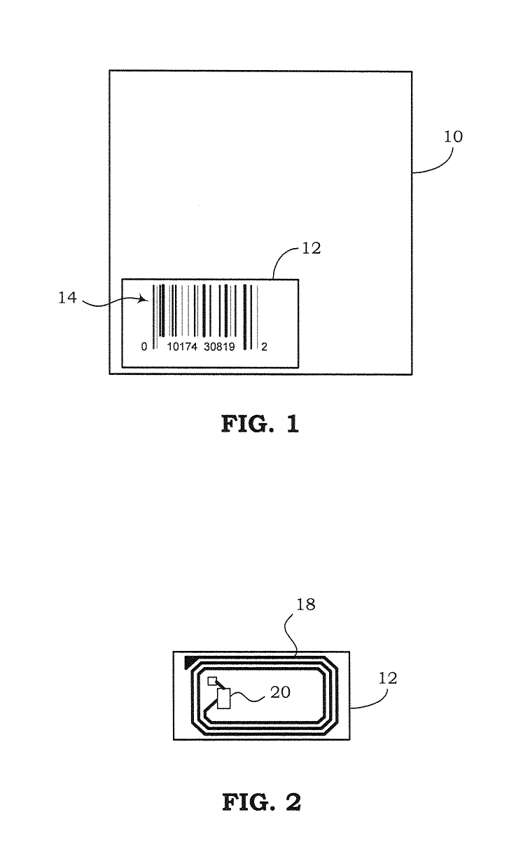

FIG. 1 is a diagram illustrating an embodiment of an inventory item 10. The inventory item 10 may be any type of retail item, rental item, or other item for which tracking is needed. The type of inventory item 10 in various implementations may depend on the type of store or facility utilizing the inventory locating systems disclosed in the present disclosure. For example, the inventory item 10 may be a DVD, book, article of clothing, furniture, food item, electronic device, or any other item that may be on sale or available for rent. The inventory items 10 may also include library books, hospital supplies, school or office equipment, or other items for which an entity may wish to track or monitor. Attached to the inventory item 10 is an RFID tag 12, which may have any suitable size or shape. The RFID tag 12 may be integrated, according to some embodiments, with a barcode 14 as shown.

FIG. 2 is a diagram illustrating an embodiment of an underside of the RFID tag 12 shown in FIG. 1. Each RFID tag 12 may store identification information that is unique to each item 10 or may store information that is unique for the same products. As illustrated in this embodiment, the underside of the RFID tag 12 includes an antenna 18, an integrated circuit 20, and memory 22. The memory, for example, may include non-volatile memory for storing information identifying the inventory item 10. The antenna 18 may be a coil antenna, as shown, or may include other suitable shapes. The antenna 18 is configured to receive radio frequency (RF) electromagnetic energy from a reader and transmit identification information back to the reader. The antenna 18 may have any suitable size and shape to enable communication with the reader when the RFID tag 12 and reader are within a predetermined distance from each other. The integrated circuit 20 may be configured to process signals received from the reader and retrieve identification information from memory 22. In some embodiments, the RFID tag 12 is a passive device that does not include a battery. Instead of producing power on its own, the RFID tag 12 may be configured to convert the electromagnetic energy transmitted by the reader to an energy level sufficient to power the integrated circuit 20.

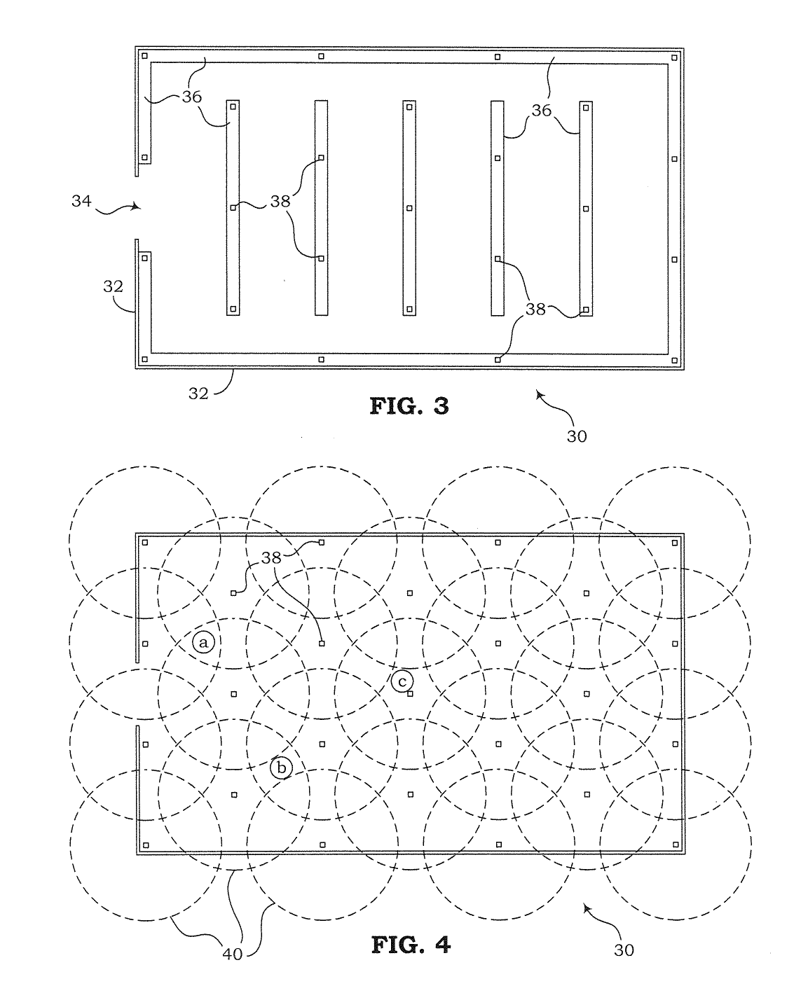

FIG. 3 is a diagram illustrating an embodiment of an exemplary floor plan 30 of an exemplary building (e.g., a retail store). In this embodiment, the floor plan includes a number of walls 32 forming an interior space, an entryway 34, and a number of shelves 36 arranged next to the walls 32 and also throughout the interior space. In some embodiments, the shelves 36 may additionally or alternatively include display structures, cabinets, racks, countertops, or other fixtures. It should be recognized that the floor plan of FIG. 3 is for illustration purposes only and does not necessarily represent any specific store. The store may have any size, shape, floor plan, etc., and may include shelves, cabinets, counters, and other fixtures arranged in any configuration.

In order to set up the inventory location systems described in the present disclosure, RFID readers 38 are arranged throughout the store. For example, the RFID readers 38 may be attached to or supported by the shelves 36 in any suitable manner. In other embodiments, such as when the shelves are not arranged in a manner to allow adequate coverage to all areas of the building or when the shelves (or other fixtures) are unable to support the RFID readers 38, the RFID readers may be attached to the ceiling, suspended from the ceiling, or attached to structures (e.g., trelliswork, beams, air-conditioning ducts, etc.) located above the space where people can normally reach. In other embodiments, the RFID readers 38 may be inserted below the floor space. In some embodiments, the RFID readers 38 may be located in any combination of spaces anywhere from below the foot to above the head, depending on the particular building configuration and/or preferences. In some embodiments, the RFID readers 38 may be mounted on pole-like structures, which may be attached to the shelves 36 or other structures.

According to some implementations, the RFID readers 38 may be arranged as illustrated in FIG. 3, wherein the RFID readers 38 are positioned in straight rows and separated by equal distances, and wherein every other row is offset by half the distance between the RFID readers 38. In this way, the RFID readers 38 are placed at substantially equal distances from up to six other readers, and thus the ranges of the RFID readers can create a specific coverage pattern. In some embodiments, the arrangement may include an array of RFID readers 38 where they are formed in substantially straight rows and columns. Other patterns may be used depending on the range of the RFID readers 38, location of walls 32 and shelves 36, or other factors.

FIG. 4 is a diagram illustrating the store floor plan 30 shown in FIG. 3 with the corresponding ranges of the RFID readers 38. The range refers to the space within which an RFID tag is located, such that when the RFID reader 38 emits an electromagnetic energy, it is able to adequately receive identification information back from the RFID tag. In some embodiments, the range of each RFID reader 38 may be about ten feet. As shown, the RFID readers 38 are arranged in an offset array pattern to maximize coverage throughout the building. When the electromagnetic fields 40 from each RFID reader 38 are radiated equally in all directions, the pattern of the range of electromagnetic fields 40 is somewhat spherical and is shown in FIG. 4 as circular dashed lines. The RFID readers 38 may be spaced apart in such a way that there will be some overlap between the ranges. Thus, some areas, such as the area indicated as “a”, may be within range of three different RFID readers 38. Other areas, such as the area indicated as “b”, may be within range of two different RFID readers 38. Yet other areas, such as the area indicated as “c”, may be within range of only one RFID reader 38.

When an inventory item 10 having an RFID tag 12 is within range of one, two, or three of the RFID readers 38, it may be possible to narrow down the search area to a small region where only one reader or where multiple readers are nearby. As shown in FIG. 4, the RFID readers 38 may be arranged as illustrated such that a known range of each reader produces the patterns shown somewhat like that of the electromagnetic field ranges 40. As a result, the overlapping ranges create manageable regions where a user (e.g., a customer or store employee) may look to find a desired item. A similar pattern as shown in FIG. 4 may be used with the RFID readers 38 arranged in the floor space and/or ceiling space of the store, regardless of the location of shelves or other structures where inventory items may normally be located. Thus, when arranged in this manner, it is possible to indicate the location of the desired item with fairly narrow precision.

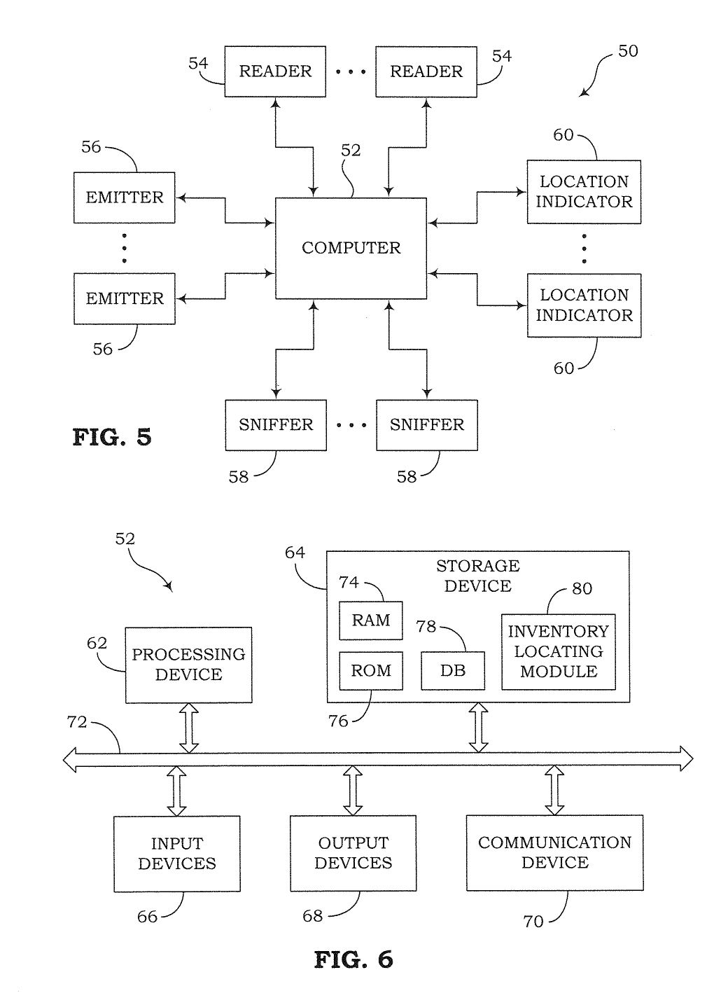

FIG. 5 is a block diagram illustrating an embodiment of an inventory locating system 50. In this embodiment, the inventory locating system 50 comprises a computer 52, a plurality of readers 54, a plurality of emitters 56, a plurality of sniffers 58, and a plurality of location indicators 60. In some embodiments, some or all of the readers 54 may include both emitters 56 and sniffers 58 integrated in the same housing, and therefore some or all of the emitters 56 and sniffers 58 may be omitted. According to other embodiments, some or all of the readers 54 may be omitted and the inventory locating system 50 may utilize the emitters 56 and sniffers 58 as separate devices. With respect to FIGS. 3 and 4, each RFID readers 38 may represent either a reader 54 in some implementations or a sniffer 58 in other implementations. Each emitter 56 may be paired with a single sniffer 58 or may be configured to operate with multiple sniffers 58, such that multiple sniffers 58 may be able to obtain the identification information from respective RFID tags 12 when stimulated by the emission energy from one emitter 56.

The computer 52 is configured to communicate with each of the readers 54, emitters 56, sniffers 58, and location indicators 60. Communication may be made via electrical wires coupled between the computer 52 and the other devices. In addition to electrical coupling for communication purposes in this regard, the electrical wires may also be configured to provide power to the distributed devices. In other embodiments, the computer 52 may communicate with the readers 54, emitters 56, sniffers 58, and location indicators 60 via wireless channels, such as by using a Wi-Fi, Bluetooth, or other short range communication protocol. When wireless communication is used, the distributed devices may be powered by batteries or may be powered by electrical line power.

In operation, the computer 52 is configured to receive an indication via a user interface that a user desires to determine the location of a certain inventory item 10. The computer 52 retrieves the identification information related to the desired item and instructs the readers 54 and/or emitters 56 to emit an initialization command signal. However, the computer 52 does not instruct the emitting devices to emit the initialization command signals at the same time, but uses a sequential order to allow for analysis at different areas at different times. After the emission of the initialization signal, the readers 54 and/or sniffers 58 are then configured to read a response from the desired item, if that item is within range. As suggested above, one or more of the readers 54 and/or sniffers 58 may be within range to pick up the response. The readers 54 and/or sniffers 58 then communicate to the computer 52 whether or not a response was received from the item. The readers 54 and/or sniffers 58 may be configured to discriminate among several RFID tags that are within range and may read the responses substantially simultaneously. However, only one RFID tag is of interest in this case (or perhaps a group of RFID tags if they represent the same product and are identified as the same item). The computer 52 processes the responses to determine an area where the desired item is located and provides an indication to communicate this location to the user (e.g., customers or employees) in the building.

The location indicators 60 may be configured in various ways. According to some embodiments, the location indicators 60 may be configured as a light or other visual indication device. For example, the light may include a light bulb, light emitting diodes (LEDs), liquid crystal displays (LCDs), or other illumination device. The location indicators 60 may also be configured as any suitable type of audible indication device, such as a buzzer, speaker, bell, etc. The indicators may be a visual representation such as a map of where the item is and may be communicated to a store employee or directly to a user on the user's mobile device. In some embodiments, the location indicators 60 may include both visual and audible outputs. The location indicators 60 may be positioned with respect to the RFID readers 38, readers 54, or sniffers 58 to indicate a range within which the desired inventory item 10 is located with respect to the particular reader 54 or sniffer 58. In this respect, the location indicators 60 may be positioned near or integrated with the corresponding device that sniffs the response from the inventory item 10. Therefore, if only one location indicator 60 provides an output, then it can be determined that the desired inventory item 10 is close to the corresponding reader. If two location indicators 60 provide an output, then it can be determined that the desired inventory item 10 is somewhere in an area near or between the corresponding readers. If three location indicators 60 provide an output, then it can be determined that the desired inventory item 10 is approximately in a triangular region formed by the three readers.

According to additional implementations, the location indicators 60 may be positioned in the various areas as shown in FIG. 4 (e.g., in the “triangular” areas such as those indicated by “a”, in the “rectangular” areas such as those indicated by “b”, and in the “hexagonal” areas such as those indicated by “c”). Thus, when the computer 52 determines that a single reader 54 (or sniffer 58) detects a response, the computer 52 instructs the location indicator 60 located in the respective “c” area to provide an output. When two readers 54 (or sniffers 58) detect responses, the location indicator 60 located in the respective “b” area provides an output. And when three readers 54 (or sniffers 58) detect responses, the location indicator 60 located in the respective “c” area provides an output.

FIG. 6 is a block diagram illustrating an embodiment of the computer 52 shown in FIG. 5. In this embodiment, the computer 52 includes a processing device 62, a storage device 64, input devices 66, output devices 68, and a communication device 70, each interconnected via a bus 72. The storage device 64 in this embodiment is configured to include various types of memory for storing digital data in volatile and/or non-volatile memory. The memory of the storage device 64 includes RAM 74, ROM 76, and a database 78. The storage device 64 is also configured to store software for performing RFID processes, such as an inventory location module 80, which includes logic and functionality according to various implementations described in the present disclosure for enabling the computer 52 to locate inventory items.

The processing device 62 may include a processor, microprocessor, microcontroller, digital signal processor, central processing unit, and/or other types of processing components. In accordance with alternative embodiments, the inventory locating module 80 may be configured as hardware and integrated with the processing device 62. The memory of the storage device 64 may include various types of RAM 74, ROM 76, flash memory, or any other suitable types of memory.

The input devices 66 may include keyboards, keypads, computer mouse devices, microphones, or other components for receiving an input from a user. The output devices 68 may include display screens, speakers, monitors, or other components for providing output to the user.

The communication device 70 may include any suitable type of interface device for communicating signals from the computer 52 to the other elements as shown in FIG. 5. Also, the communication device 70 receives signals from these other elements. The communication device 70 may include components for enabling wireless communication with the elements or may include various switching circuits and coupling components for communicating with the elements via wired connectors.

The database 78 may be configured to store a list or table of a plurality of inventory items 10 that are intended to be tracked. Each inventory item 10 is configured to include an RFID tag 12 attached thereto. The RFID tag 12 includes a unique identification number that may be used to define the inventory item 10. Inventory items 10 that are the same product (e.g., Batman DVDs) may share the same identification information according to some embodiments or may each have a unique number according to other embodiments. The database 78 may also be configured to store information related to the RFID readers 38, such as their location in the building, their arrangement with respect to one another, store mapping information positioning height, or other information related to location, range, etc.

When a user (e.g., customer or employee) wishes to determine the location of an inventory item 10, the user enters an identification of the item via an input device 66, such as a user interface. For example, the inventory locating module 80 may provide a list of the items to the user via the user interface, or other output device 68, such that the user may select the desired item from the list. The inventory locating module 80 may also include search functionality to allow the user to find an identification (e.g., name) or other search fields of the item. When a desired item is selected using any suitable selection methodologies, the inventory locating module 80 begins an inventory locating process.

The inventory locating module 80 instructs the communication device 70 to send the identification information associated with the desired inventory item to a first RFID reader 38, reader 54, and/or emitter 56. The RFID readers 38, readers 54, and/or emitters 56 and the corresponding RFID tags 12 may be configured to utilize any suitable protocol for singling out one particular RFID tag 12 in the midst of many tags. For example, a slotted Aloha protocol may be used in which the emitting device (e.g., RFID reader 38, reader 54, or emitter 56) emits an initialization command. Using a pseudo-random delay, each tag 12 within range is configured to provide a response. The RFID reader 38, reader 54, or sniffer 58 that is paired with or associated with the emitting device is configured to receive the responses from the tag(s) 12. For example, the inventory locating module 80 may be responsible for managing a table or list that defines which reader(s) and/or sniffer(s) are configured to operate with each reader and/or emitter. Therefore, when a certain emitting device (reader 54 or emitter 56) is instructed to emit, instructions are then sent to the readers 54 and sniffers 58, associated with the emitting device, to sniff for responses from the RFID tags 12.

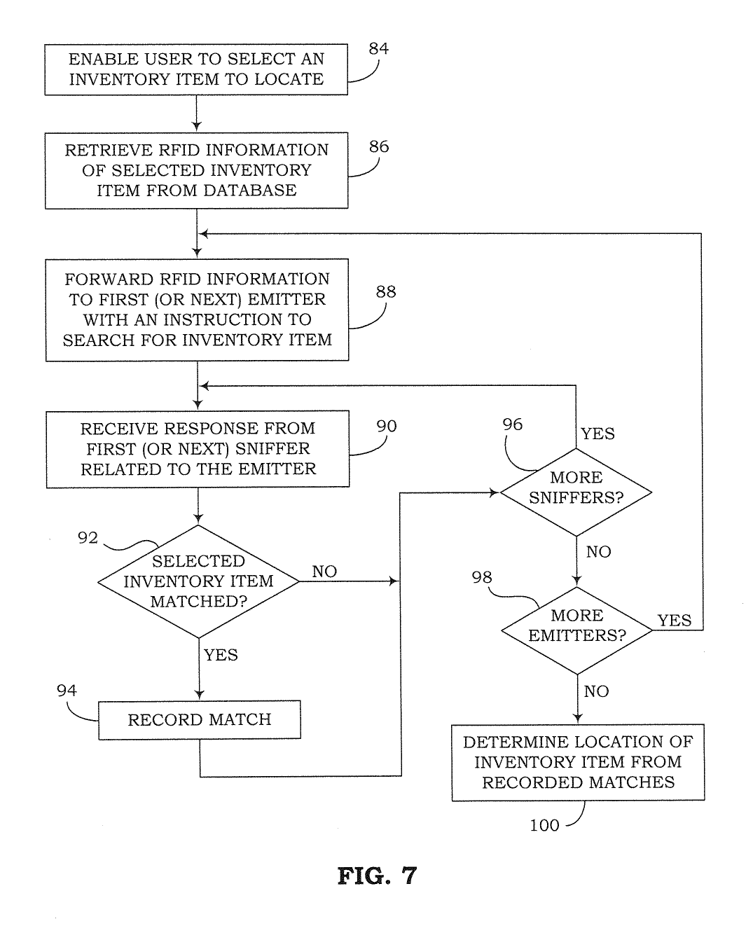

FIG. 7 is a flow diagram illustrating an embodiment of a method for detecting an approximate location of an inventory item. For example, the method may be performed by the inventory locating module 80. The method comprises a first step of enabling a user to select an inventory item to locate and thereby receiving a selection of the inventory item, as indicated in block 84. The selection may be made from a list of inventory items that are sold or rented by a store. As indicated in block 86, the method further includes the step of retrieving RFID information of the selected inventory item from a database. The RFID information includes a unique number (e.g., serial number, barcode number, etc.) associated with an RFID tag that is attached to the inventory item. The method further comprises the step, as indicated by block 88, of forwarding the RFID information to a first (or next) emitter with an instruction to search for the inventory item.

The process of searching for the inventory item is performed by each emitter arranged in a specific location to enable RF communication with the RFID tags within range of the emitter. The emitter and corresponding RFID tags may use a protocol that allows the emitter to single out one specific tag among a plurality of tags. The emitter transmits an initialization signal. According to some protocols, the tags may be configured to impose a delay upon themselves using a pseudo-random generator to respond with identification information after the delay. A reader or sniffer, which is configured according to the systems described in the present disclosure to be associated with the respective emitter, sniffs the responses from the tags within range and determines whether or not a tag matches the identification information corresponding to the selected inventory item. If a match is found, the reader or sniffer sends an indication of the match to the computer 52. According to other protocols (e.g., an adaptive binary tree procedure), the emitter may be configured to continue emitting information after the initialization signal is emitted. For instance, the emitter may transmit one bit of the identification information at a time and the sniffer receives a response when there is a match. If an entire identification string of a tag matches the emitted string, then the sniffer determines that the selected inventory item has been found. This information is also communicated to the computer 52.

Returning to FIG. 7, the method further comprises the step of receiving a response from the first (or next) sniffer corresponding to the emitter, as indicated in block 90. The information from the sniffer may include an indication as to whether or not a match was found. As indicated in decision block 92, it is determined whether or not the selected inventory item was matched with a tag having the same identification information. This is an indication that the selected inventory item is within range of the sniffer. If a match was found, the method records the match, as indicated in block 94, and proceeds to block 96. If no match is found, the method skips block 94 and goes directly to block 96. According to decision block 96, it is determined whether or not any more sniffers are within range of the respective emitter. This step may be needed if more than one sniffer corresponds to an emitter. However, if a reader includes both an emitter and sniffer operating as one unit, this step would be unnecessary and could be omitted in those embodiments. Nevertheless, if more sniffers are applicable, the method loops back to block 90 to receive a response from the next sniffer. If no more sniffers are related to the emitter, the method proceeds from decision block 96 to decision block 98.

As indicated in decision block 98, the method includes determining whether or not there are more emitters in the inventory locating system that are to be energized to produce the electromagnetic field, in the process of searching for the selected inventory item. If more emitters are to be used, the method loops back to block 88 to enable the next emitter to search for the inventory item. According to some embodiments, if a match is recorded in block 94, the computer 52 may be configured to analyze the arrangement of the emitters in order to determine which additional emitters are needed for more searching. For example, if one emitter finds a match on one end of the store, it may be unnecessary to enable searching by emitters on the other end of the store, but it may be determined that the emitters closest to the matching emitters may be utilized. In this way, the matching emitter and one or more other nearby emitters may provide a match to indicate a specific overlapping region within ranges of the emitters. If it is determined in block 98 that no more emitters are needed, the method proceeds to block 100. As indicated in block 100, a location of the inventory item is determined from the recorded match or matches, if any. If no matches are found, an indication may be provided that the location of the item was not found. When the location is determined, the inventory locating module 80 may be configured to display a map of the store on an output device 68 to show the customer or employee the general area where the desired inventory item is located. In other embodiments, the step 100 of determining the location may also include providing visual and/or audible signals at various locations throughout the store to direct the customer or employee to the located item.

The various implementations described herein are not intended to limit the present disclosure, but may include additional features and advantages not necessarily expressed herein. The additional features and advantages may be apparent to one of ordinary skill in the art upon examination of the detailed description and accompanying drawings, according to spirit and scope of the present disclosure. It is intended that all such additional features and advantages be included within the present disclosure and protected by the accompanying claims.

1. A system comprising:
a plurality of inventory items;
a radio frequency identification (RFID) tag attached to each of the plurality of inventory items;
a plurality of RFID readers positioned at predetermined, stationary locations throughout a search area;
a computer configured to determine a location of a selected inventory item based at least on search results of the RFID readers.

2. The system of claim 1, wherein at least one of the RFID readers comprises an emitter and a sniffer.

3. The system of claim 2, wherein the emitter and sniffer are integrated in a single housing.

4. The system of claim 1, further comprising a plurality of location indicating devices configured to indicate the determined location of the selected inventory item.

5. The system of claim 4, wherein each location indicating device comprises a light.

6. The system of claim 5, wherein one or more of the lights of the locating indicating devices is positioned in the middle of a region between two or three RFID readers.

7. The system of claim 1, wherein the computer comprises a communication device for wirelessly communicating with the RFID readers.

8. The system of claim 4, wherein each location indicating device comprises an audible indication device.

9. The system of claim 1, further comprising a visual mapping indicator to indicate the determined location of the selected inventory item.

10. A computer program stored on a non-transitory computer-readable medium, the computer program configured to enable a processing device to:
receive a user selection from an input device, the user selection related to an inventory item selected from among a plurality of inventory items;
retrieve radio frequency identification (RFID) information associated with the selected inventory item from a database;
sequentially communicate the RFID information to a plurality of RFID readers positioned in predetermined, stationary locations throughout a search area;
receive search results from the plurality of RFID readers; and
determine a location of the selected inventory item within the search area based at least on the search results.

11. The computer program of claim 10, wherein the computer program further enables the processing device to provide an indication of the determined location to the user.

12. The computer program of claim 11, wherein the computer program further enables the processing device to display the determined location via an output device configured to provide the determined location on a map of the search area.

13. A method comprising:
enabling a user to select an inventory item using a user interface device;
retrieving radio frequency identification (RFID) information associated with the selected inventory item from a database;
sequentially communicating the RFID information to a plurality of RFID readers placed in predetermined, stationary locations throughout a search area;
receiving search results from the plurality of RFID readers; and
determining a location of the inventory item within the search area based at least on the search results.

14. The method of claim 13, wherein the search area is an interior space of a building.

15. The method of claim 13, wherein the RFID readers are placed in an array pattern.

16. The method of claim 15, wherein odd columns of the array pattern are offset from even columns.

17. The method of claim 13, wherein the RFID readers are supported by shelves within the search area.

18. The method of claim 13, further comprising the step of providing an indication of the determined location to the user.

19. The method of claim 18, wherein the step of providing the indication comprises the step of displaying the determined location on a map of the search area, wherein the map is shown on an electronic display.

20. The method of claim 18, wherein the step of providing the indication comprises the step of displaying the determined location on a map of the search area, wherein the map is shown on mobile device.

21. The method of claim 18, wherein the step of providing the indication comprises the step of providing at least one visual output in or near the determined location.

22. The method of claim 21, wherein the step of providing the indication further comprises the step of providing at least one audio output in or near the determined location.

23. The method of claim 13, wherein the search results are obtained by discriminating the RFID information associated with the selected inventory item from the RFID information associated with other inventory items.

24. A method comprising:
enabling a user to select an inventory item using a user interface device;
retrieving radio frequency identification (RFID) information associated with the selected inventory item from a database;
sequentially communicating the RFID information to a plurality of RFID readers placed in predetermined, stationary locations throughout a search area, each of the RFID readers having a predetermined search range, wherein the plurality of RFID readers are arranged so that the search ranges of adjacent RFID readers overlap;
receiving search results from the plurality of RFID readers; and
determining a location of the inventory item within the search area based the search results from at least two RFID readers.
